(19) United States
(12) Patent Application Publication
(10) Pub. No.: US 2025/0044185 A1
(43) Pub. Date: Feb. 6, 2025

(54) TEST DEVICE FOR AERONAUTICAL COMPONENT

(71) Applicant: LEONARDO S.P.A., ROMA (IT)

(72) Inventor: Felice Menafro, Torino (IT)

(73) Assignee: LEONARDO S.P.A., ROMA (IT)

(21) Appl. No.: 18/706,842

(22) PCT Filed: Oct. 14, 2022
(86) PCT No.: PCT/IB2022/059861

§ 371 Date: May 2, 2024

(30) Foreign Application Priority Data
Nov. 19, 2021 (IT) 102021000029351

(51) Int. Cl. G01M 7/08

(52) U.S. Cl. CPC G01M 7/08

(57) ABSTRACT

Test device for an aeronautical component (2) wherein M low-energy impacts are performed on the component to be subjected to testing (2) by calculating the relative uncertainty Ui of the non-destructive tests. A destructive test (block 120) is performed on the aeronautical component (2) by measuring and storing the value of a quantity VI representative of the elastic stress applied to the component during the destructive test and based on this the uncertainty of the destructive test is calculated (block 130). The absolute value of the difference between target values of quantities Ci based on a theoretical model that describes the elastic behaviour of the component to be subjected to testing and the value of the quantity VI representative of the elastic stress applied to the component during the destructive test (ABS (Ci-Vi)) is compared with the product of the uncertainty of the destructive test AI and a scaling factor k in order to certify the theoretical model as describing with sufficient accuracy the behaviour of the aeronautical component during the destructive test.

### CROSS-REFERENCE TO RELATED APPLICATIONS

This Patent Application claims priority from Italian Patent Application No. 102021000029351 filed on Nov. 19, 2021, the entire disclosure of which is incorporated herein by reference.

### TECHNICAL FIELD

The present invention relates to a test device for an aeronautical component.

### BACKGROUND OF THE INVENTION

In order to obtain the aeronautical certification for aeronautical components, a series of laboratory tests are envisaged, including destructive tests (“Impact/Crash Test”) in which the aeronautical component is subjected to a stress having an energy such as to irreversibly modify the shape and structure of the aeronautical component.

Destructive type tests include, by way of example, the bird strike test in which a pneumatic cannon fires at high speed (up to 450 miles per hour) a bird (usually a chicken or a jelly simulating the bird) with a specified weight (usually 1.5 to 8 pounds) against the aeronautical component from a specified distance. The impact is video-recorded using high-speed video equipment and the real-time speed is measured at each shot. A post-test damage assessment is also performed.

Obviously, the aeronautical component, following a destructive type test, is no longer intact and it is not possible to perform a subsequent “Impact/Crash Test” on the same component.

The main drawback of the “single tests” is that it is not possible to estimate the uncertainty of the results (measurements) obtained from the test itself. The estimation of uncertainty is necessary to certify the theoretical models, i.e. to demonstrate that these models are able to predict the test results with an accuracy that corresponds to the uncertainty of the experimental measurements and thus are also able to predict the actual operating conditions.

Patent US 2013/298690 describes a method and an apparatus for identifying the position of the load on a structure. Various embodiments include calculating a plurality of potential loading sites, evaluating the statistical order of each of such predictions, and selecting the regions of the structure where the load most likely occurred based on the order (or randomness) of the evaluations.

### SUMMARY OF THE INVENTION

Aim of the present invention is to provide a test device for aeronautical component that provides uncertainty of the result of a destructive type test thus making it possible to verify whether a theoretical model that simulates such a test has similar uncertainty and therefore the test model is valid. This aim is achieved by the test device of claim 1.

### BRIEF DESCRIPTION OF THE DRAWINGS

For a better understanding of the present invention, a preferred embodiment is described below, by way of non-limiting example, with reference to the accompanying figures wherein:

FIG. 1 schematically shows a test device realized according to the present invention; and

FIG. 2 shows the control and calculation operations carried out by an electronic unit of the device of FIG. 1.

### PREFERRED EMBODIMENT EXAMPLE

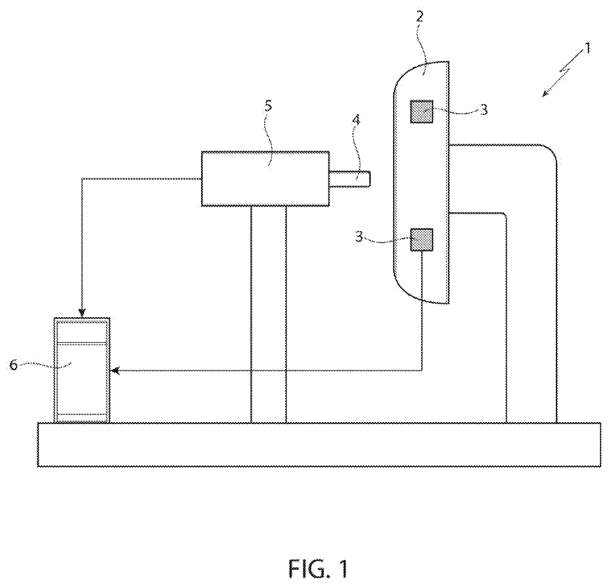

In the test device according to the present invention, an aeronautical component 2 to be subjected to testing is arranged on a test bench 1 (FIG. 1) and provided with one or more sensors 3 (of known type) adapted to measure on the aeronautical component 2 a series of physical quantities deriving from the application of forces to the component to be subjected to testing 2.

These forces have values such that they do not irreversibly deform the component 2 to be subjected to testing (low-energy impact). For example, there may be provided a plurality of accelerometers 3 adapted to measure the accelerations present on the component to be subjected to testing 2 following the impact of the end portion 4 of an actuator 5 adapted to generate this force. The actuator 5 is controlled by a computerized control unit 6 that receives the signals coming from the one or more sensors 3 and realizes the method of the present invention. The electronic control unit is provided with an internal memory for storing the acceleration values detected.

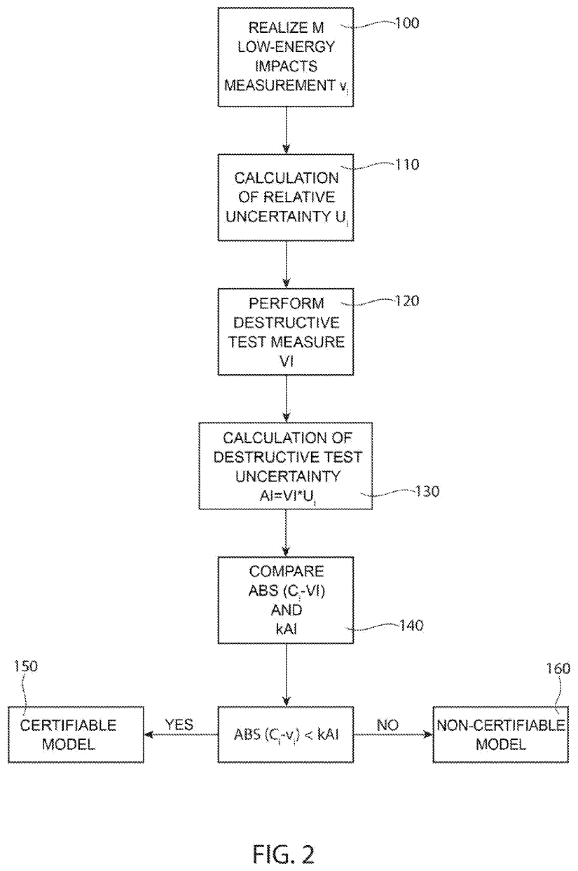

In particular, the following steps are carried out by the computerized control unit 6 (FIG. 2):
a) control (block 100) the actuator 5 to perform a series of non-destructive M tests wherein M low-energy impacts are performed on the component to be subjected to testing 2 and for each impact performed, the value of a quantity vi representative of the elastic stress applied to the component during the non-destructive test is measured and stored, in the example shown the quantity corresponds to the acceleration measured by the sensor(s) 3; for the signal produced by each sensor the mean value Vm of the M quantities measured vi and the standard deviation σ of the M quantities measured (mean quadratic deviation) is calculated;
b) calculate (block 110) the relative uncertainty Ui of the non-destructive tests as the ratio between the mean of the standard deviations and the mean of the detected quantities—this operation is carried out assuming that the values of “Relative Uncertainty” Ui are independent of the impact energy applied in the execution of the test;
c) control the actuator 5 to perform a destructive test (block 120) on the aeronautical component to be subjected to testing 2 (the test may be performed by the actuator 5 or by other means, for example by the impact of an object on the aeronautical component) and measure and store the value of a quantity VI representative of the elastic stress applied to the component during the destructive test,
d) calculate (block 130) the uncertainty of the destructive test AI by multiplying the value of the quantity VI representative of the elastic stress applied to the component during the destructive test by the value of Relative Uncertainty Ui previously calculated, namely:

AI=VI×Ui;
e) compare (block 140) the absolute value of the difference between target values of quantities Ci based on a theoretical model that describes the elastic behaviour of the component to be subjected to testing and the value of the quantity VI representative of the elastic stress applied to the component during the destructive test (ABS (Ci-Vi)) with the product of the uncertainty of the destructive test AI calculated in point d) with a scale factor k;
f) if said absolute value is less than said product, the theoretical model developed is considered certifiable (block 150) and namely describing with sufficient accuracy the behaviour of the aeronautical component during the destructive test, namely: (ABS (Ci-Vi))<k AI→certifiable theoretical model.
g) if said absolute value is not less than said product, the theoretical model developed is considered non-certifiable (block 160) and namely not describing with sufficient accuracy the behaviour of the aeronautical component during the destructive test, namely: (ABS (Ci-Vi))<k AI→non-certifiable theoretical model.

In other words, the computerized unit performs a series of Low-Energy elastic stresses before the Crash test in order to produce a matrix containing the relative uncertainties at each instant of the low-energy impacts, and finally, after the impact has occurred, the measurement uncertainty is generated starting from the matrix.

### NUMBERS

1 test bench
2 aeronautical component
3 sensors
4 end portion
5 actuator
6 computerized control unit

1. A test device for an aeronautical component (2) comprising actuator means (5) controlled by an electronic control unit (6) and configured to apply a force to the component being tested (2),
said test device comprising sensors (3) adapted to measure on the aeronautical component (2) physical quantities deriving from the application of forces to the component to be subjected to testing (2);
said test device comprising memory means for storing the measured physical quantities;
said electronic control unit (6) being configured to:
a) control (Block 100) the actuator means (5) to perform a series of non-destructive M tests wherein M low-energy impacts are performed on the component to be subjected to testing (2) and for each impact performed, the value of a quantity vi representative of the elastic stress applied to the aeronautical component (2) during the non-destructive test is measured and stored; the mean value Vm and the standard deviation σ of the measured M quantities vi are calculated;
b) calculate (Block 110) the relative uncertainty Ui as the ratio between the mean of the standard deviations and the mean of the detected quantities;
c) control the actuator (5) to perform a destructive test (block 120) on the aeronautical component to be subjected to testing (2) by measuring and storing the value of a quantity VI representative of the elastic stress applied to the component during the destructive test,
d) calculate (block 130) the uncertainty of the destructive test AI by multiplying the value of the quantity VI representative of the elastic stress applied to the component during the destructive test by the value of Relative Uncertainty Ui previously calculated, namely: AI=VI×Ui;
e) compare the absolute value of the difference between target values of quantities Ci based on a theoretical model that describes the elastic behaviour of the component to be subjected to testing and the value of the quantity VI representative of the elastic stress applied to the component during the destructive test (ABS (Ci-Vi)) with the product of the uncertainty of the destructive test AI calculated in point d) with a scale factor k; if said absolute value is less than said product, the theoretical model developed is considered certifiable and namely describing with sufficient accuracy the behaviour of the aeronautical component during the destructive test, namely: (ABS (Ci-Vi))<k AI→certifiable theoretical model.

2. Test device according to claim 1, wherein said sensors (3) comprise a plurality of accelerometers arranged on the aeronautical component (2) and adapted to detect said quantity vi.
